(19) United States
(12) Patent Application Publication
(10) Pub. No.: US 2012/0019572 A1
(43) Pub. Date: Jan. 26, 2012

(54) BACKGROUND AND FOREGROUND COLOR PAIR

(75) Inventor: Ruth Ann Lim, Santa Clara, CA (US)

(73) Assignee: HEWLETT-PACKARD DEVELOPMENT COMPANY, L.P., Houston, TX (US)

(21) Appl. No.: 13/260,253

(22) PCT Filed: Mar. 31, 2009
(86) PCT No.: PCT/US2009/039003

§ 371 Date: Sep. 23, 2011

(51) Int. Cl. G09G 5/10

(52) U.S. Cl. 345/690

(57) ABSTRACT

A computing device includes a user input device (810); and a memory (815) comprising a display driver (820), a first color matrix (202) and a second corresponding color matrix (208). A user interface (825) of the display driver (820) is configured to match a color selected with the user input device (810) in the first color matrix (202) with a color in the second color matrix (208) to identify a background and foreground color pair and to display background and foreground elements on a display device (805) using the color pair.

### BACKGROUND

Many software applications have a graphical user interface (GUI) which allows the user to interact with the application. In order to meet the demands and preferences of consumers, many software applications are equipped with an interface that includes options for customizing the appearance of the interface. Many users choose to take advantage of these types of features and customize the appearance of the GUI to suit their own personal preferences.

Among the many ways a user may customize the interface appearance is to change the color scheme, including the background color or the foreground color. The foreground typically involves principal content such as text, graphics, window frames, etc. The background is typically a color or pattern that surrounds the principal or foreground content. Users will often judge the desirability of a software application partly on its overall appearance and the ability they have to modify the appearance to suit their preferences.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is an illustration of a background color vs. a foreground color, according to one embodiment of principles described herein.

FIG. 2 is a drawing of two matrices, one associated with a user selected background color, and the other associated with a matched foreground color matrix, according to one embodiment of principles described herein.

FIG. 3 is a drawing of an illustrative user interface for selecting a background color, according to one embodiment of principles described herein.

FIG. 4 shows an illustrative user interface for selecting a background color and a foreground color, according to one embodiment of principles described herein.

FIG. 5 is an illustrative drawing of both a background color high resolution matrix and a foreground color high resolution matrix, according to one embodiment of principles described herein.

FIG. 6 is a flow diagram which shows illustrative methods for producing a foreground and background color pair according to one embodiment of principles described herein.

FIG. 7 is a flow diagram showing an illustrative method of making a user interface for selecting a foreground and background color pair according to one embodiment of principles described herein.

FIG. 8 is an illustrative drawing of a computing device according to one embodiment of principles described herein.

Throughout the drawings, identical reference numbers designate similar, but not necessarily identical, elements.

### DETAILED DESCRIPTION

The present specification relates to methods and systems for choosing a foreground color based on a selected or user-defined background color. This method or system may be used in any software application capable of running on any type of computing device. As used herein and in the appended claims, the term computing device is used broadly to refer to any computing device having a user interface, including but not limited to, a desktop computer, a notebook or laptop computer, a personal digital assistant (PDA), or a cell-phone.

As mentioned above, many software applications have a graphical user interface (GUI) which allows the user to interact with the application and give commands. Most GUIs come with an option which will allow the user to change the appearance. A user may have the option of setting both the background color and the foreground color.

As mentioned above, the foreground color is typically the color with which principal content such as text, graphics, windows, on-screen controls, etc. are displayed. It is helpful that when the user is selecting a foreground color, it is contrasted enough with the background color that the display of principal content can be easily discerned.

For example, if the user has chosen a white background, a is yellow foreground color will cause the text to be yellow. It can be very difficult to read yellow text with a white background. Further, if the user chooses black as a background and chooses dark blue as a foreground, it will also be very difficult to read any text or see other elements of the foreground. In addition, though the colors may be contrasted enough to make the text legible and other foreground content ready visible, they may not match well and therefore lack an aesthetical appeal.

There are a few disadvantages to letting the user choose both the background color and the foreground color manually. For one, this involves an extra step for the user. Also, there is a possibility that the user will have difficulty finding a match which is aesthetically pleasing, legible, and minimizes strain on the eye.

To address these issues, it is possible to create a transfer function and apply it to whatever color the user has chosen as a background color. One example of a transfer function would be to perform a bitwise operation, such as the exclusive or (XOR) operation, on the bits encoding the background color. Another method may involve a relatively complex algorithm which determines a suitable “color distance” and uses the newly created color as the foreground color. Although these methods are relatively straightforward, they may not always yield an optimal result. Additionally, they consume valuable processing resources to calculate the new color.

The present specification discloses methods and systems whereby a preset foreground color matrix is created. This foreground color matrix is matched with a background color matrix. When a user selects a background color from the background color matrix, the foreground color is chosen from the color in the corresponding coordinates of the foreground color matrix or vice versa.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

As used herein and in the appended claims, the term “display device” is used broadly to refer to any physical device that might be used to visually display an image, such as a user interface, to a human user. A display device might be, but is not limited to, a monitor, television, projector, flat screen, liquid crystal display, touch sensitive screen, or other display device.

As used herein and in the appended claims, the term “user input device” is used broadly to refer to any device with which a user enters input, such as selecting a color from a color matrix. A user input device might be, but is not limited to a mouse, keyboard, stylus with touch-screen system, or any other suitable user input device.

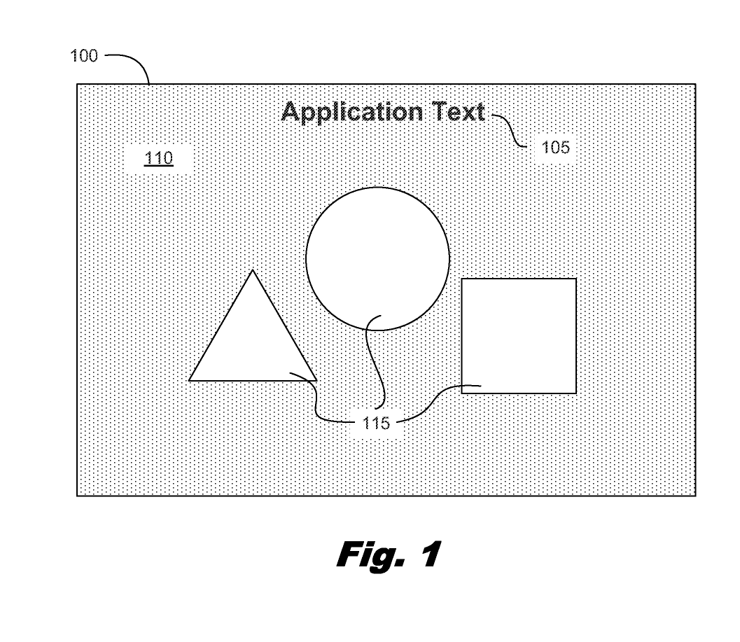

FIG. 1 is an illustrative depiction of an exemplary GUI (100). A typical GUI has a background (110) with an associated background color. The background (110) may be a solid color or a pattern comprising multiple colors. Where multiple colors are used in the background, the predominant color in the pattern, e.g., the color covering the most area, is considered the “background color” as that term is used in the present specification and claims.

The content display on the background (110), also referred to as the principal content, with have an associated foreground color. This is the color, for example, of any text (e.g., 105) displayed and the predominant color of any other foreground elements, such as graphics, window frames, etc.

As mentioned above, the user may customize the appearance of the GUI by changing the background color and/or the foreground color. It is helpful that both the background color and the foreground color are contrasted enough so that text (105) and graphics (115) are clearly recognizable.

As mentioned before, many applications have an option that will allow the user to set or adjust the coloring scheme for the GUI. As explained here, paired matrices representing the range of background and foreground colors can be used to provide an optimal relationship between a foreground and background color pair when either is selected or adjusted by a user.

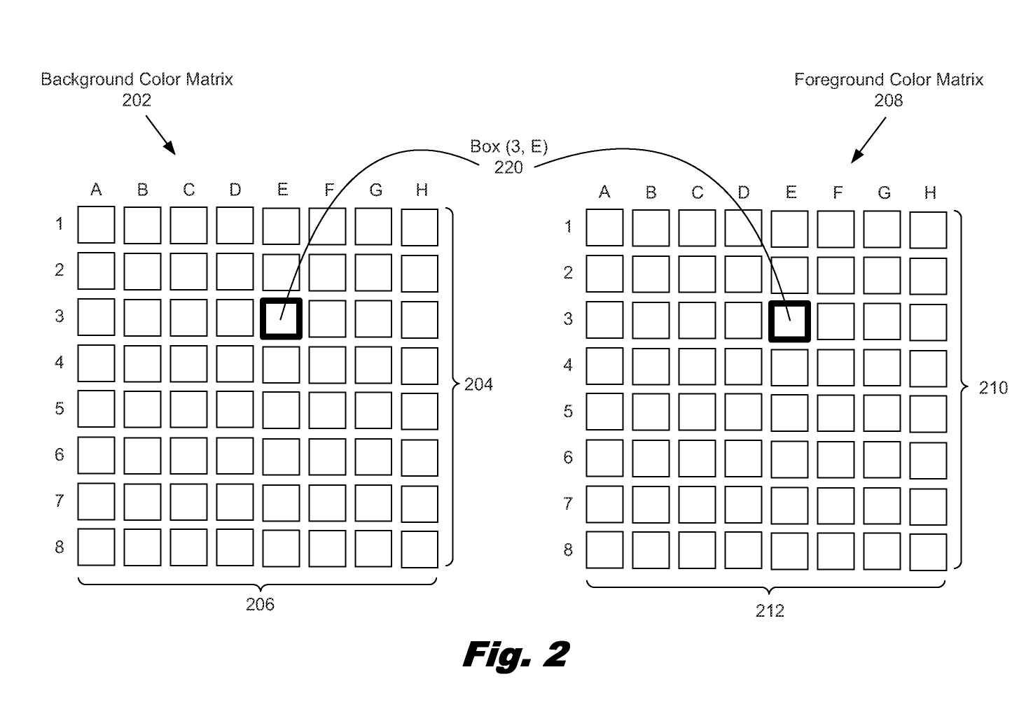

FIG. 2 is a depiction of two matched color matrices. The matrix on the left is a background color matrix (202). It is a matrix with the rows (204) labeled with the numbers 1 through 8, and the columns (206) labeled with the letters A though G. Each coordinate in the background color matrix (202) represents a specific color within the range of available background colors. In one illustrative embodiment, the colors may represent an evenly spaced span of the visible color spectrum.

The matrix on the right is a foreground color matrix (208). It also has rows (210) labeled with the numbers 1 through 8, and columns (212) labeled with the letters A through G. Each coordinate in the foreground color matrix (208) is assigned a color that will match with the same color with the same coordinates in the background color matrix. For example, if the user has chosen a box (220) from the background color matrix (202) with the coordinates (3, E). The foreground color would be automatically set to whatever color was in position (3,E) of the foreground color matrix (208). The same is true if the user selects a foreground color from the right matrix (208). The background color is then automatically set to the color at the corresponding position in the background color matrix (202) on the left.

As mentioned above, the colors in the foreground color matrix (208) can be preset by the developer of the application to match well with the associated colors in the background color matrix (202) and vice versa. Any method for determining what foreground color would match a given background color may be used. For example, the developer may create an algorithm to determine a desirable match. Also, the developer could manually choose foreground colors that will match well with corresponding background colors. The developer could use a transfer function to contrast the colors, and then adjust the new colors manually so as to be aesthetically pleasing while maintaining adequate contrast.

A good color match is one in which the foreground color is adequately contrasted with the background color so as be legible. In addition, a good color match will be aesthetically pleasing and provide a minimal amount of strain on the eye. Some color matches, though they may be legible, cause strain on the eyes after reading text for a period of time.

In FIG. 2, the two matrices are identical in size. However, in other embodiments, the two matrices may have different dimensions. For example, the foreground color matrix could have smaller dimensions than the background color matrix. In such an example, a range of coordinates in the background matrix would be mapped to only one coordinate set in the foreground color matrix. It is not necessary that each color in the foreground color matrix (208) is unique. For example, if all of the colors in the bottom row of the background color matrix (202) were different shades of a darker color, all of the corresponding colors in the foreground color matrix (208) could all be the same lighter color.

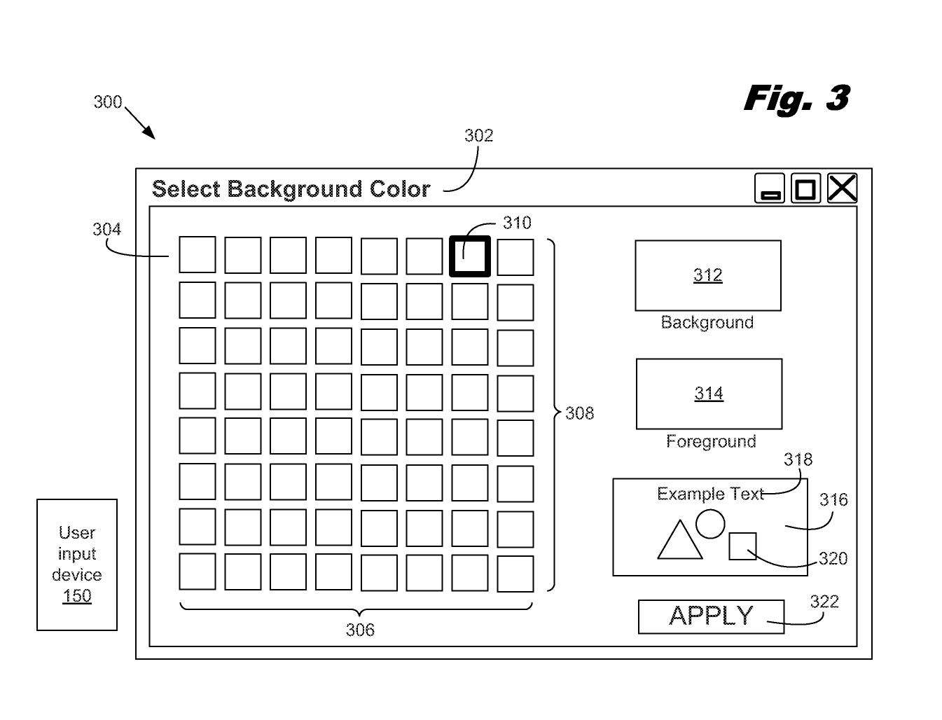

FIG. 3 is shows an exemplary user interface on a display device (300) for changing the color scheme of a GUI. In the illustrated embodiment, the option to change the background color could bring up a window. The window would have a title (302) at the top. The main section of the window would consist of a color matrix (304) similar to the background color matrix (208, FIG. 2) described above. In the illustrative embodiment shown in FIG. 3, the color matrix (304) contains eight rows (306) and eight columns (308). The user may select a desired color box from the color matrix (304). The color which the user has selected can then be marked in some way, indicating which color the user has last selected. For example, if the user selects a particular box (310), that box could be highlighted or boxed.

On the right side of the window is a box (312) with a larger area displaying the selected background color (310). This will give the user a better view of the color. Below the background color box (312) is a foreground color box (314). This box displays the assigned foreground color from a predetermined foreground color matrix (208, FIG. 2) that has been matched to the background color matrix (304).

In this embodiment, the foreground color matrix is not shown. When a user chooses a background color, the application will take the associated foreground color from memory and display it in the foreground color box (314). However, the interface (300) might alternatively display the foreground color matrix, allowing the user to select a foreground color to which a corresponding background color is the matched. In other embodiments, both matrices may be displayed in the interface (300).

Another feature which could be implemented is an example box (316) that may show a sample of the application with the chosen background color. It may also show some example text (318) in the associated foreground color along with various graphics (320) which may also use the assigned foreground color. This feature may provide a user with a more comprehensive view of what the chosen background color and assigned foreground color will look like applied to the GUI of the application.

Once the user is satisfied with the chosen background color and its associated foreground color, they may then click on a button (322) to apply the settings and exit the background color setting option window. Again, the window may be a foreground color setting option window that otherwise has the same features.

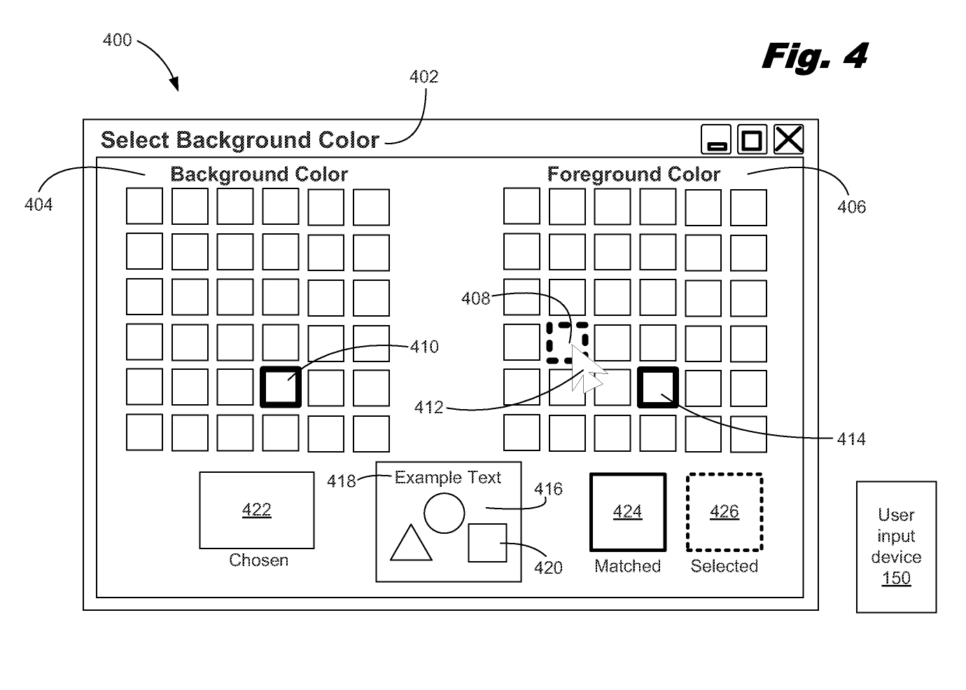

As indicated above the user interface may display both the background color matrix and the foreground color matrix in the color setting option window. FIG. 4 shows an illustrative user interface on a display device (400) for selecting a background color and/or a foreground color with such an embodiment. As shown in FIG. 4, when the user elects to change the color settings of the interface, a color setting option window would open up. At the top, a title (402) is displayed.

According to the illustrated embodiment, the background color matrix (404) is shown on the left side of the window, and the foreground color matrix (406) is shown on the right side of the window. As in the embodiment shown in the previous figure, the background color matrix (404) is a collection of colors that can be selected for setting the background color. The foreground color matrix (406) is a corresponding set of colors, each color chosen to match the background color with the same coordinates of the matrix. Once a user has selected their chosen background color, the box containing that color could be highlighted, bolded on the border, or any method which will mark that particular box as the one that the user has selected (410).

Depending on the system running the application, the user may select their chosen color with a user input device (150) such as mouse, keyboard, stylus with touch-screen system, or any other suitable user input device. In the illustrated example, a box with a larger area (422) is placed directly beneath the background color matrix (404) and used to display the chosen color, giving the user a better view of that color.

The right side of the interface (400) displays the foreground color matrix (406). The foreground color corresponding to the chosen background color (410) from the background color matrix (404) is indicated, for example by being highlighted or bolded. The color in this box (414) would be an optimized foreground color which would match the selected background color (410). As mentioned above, this color correspondence could be predetermined by the developer of the application. Beneath the foreground color matrix, a box with a larger area (424) could display the color from the box (414) associated with the user selected background color.

Some embodiments, the user would not be limited to the predetermined corresponding color which was chosen by the developer. Although the predetermined color may be the designated match as determined through whatever algorithm or method the developer used, it may not be the first choice of the user. The user may choose to ignore the suggested corresponding color and choose a different color. For example, the user may not like the suggested color as a matter of personal preference. They may then use the cursor (412) and select a different foreground color from a different box (408). Beneath the foreground color matrix (406) and to the right of the box (424) displaying the suggested foreground color, there could be another box (426) displaying the alternative color a user has selected. Allowing the user to choose an alternative foreground color will give the user a little more flexibility with the appearance of their application's GUI.

Similar to the embodiment in FIG. 3, there is an example box (416) which has the background color the user has chosen from the background color matrix (404). This box (416) also displays text (418) and graphics (420) in the foreground color suggested by the application, or an alternative color the user may have selected as discussed above. This will give the user an idea of what the appearance of the GUI will be before they choose to apply the settings. If the user has selected an alternative color, the example box (416) can help them see if their new choice is more preferable than the suggested color which matches the coordinates of the selected background color.

In addition to the foregoing examples, a background color matrix and foreground color matrix need not be limited to a relatively small amount of colors depicted by rows and columns of boxes. In some embodiments, the background and foreground color matrices could be depicted by a high resolution color gradient.

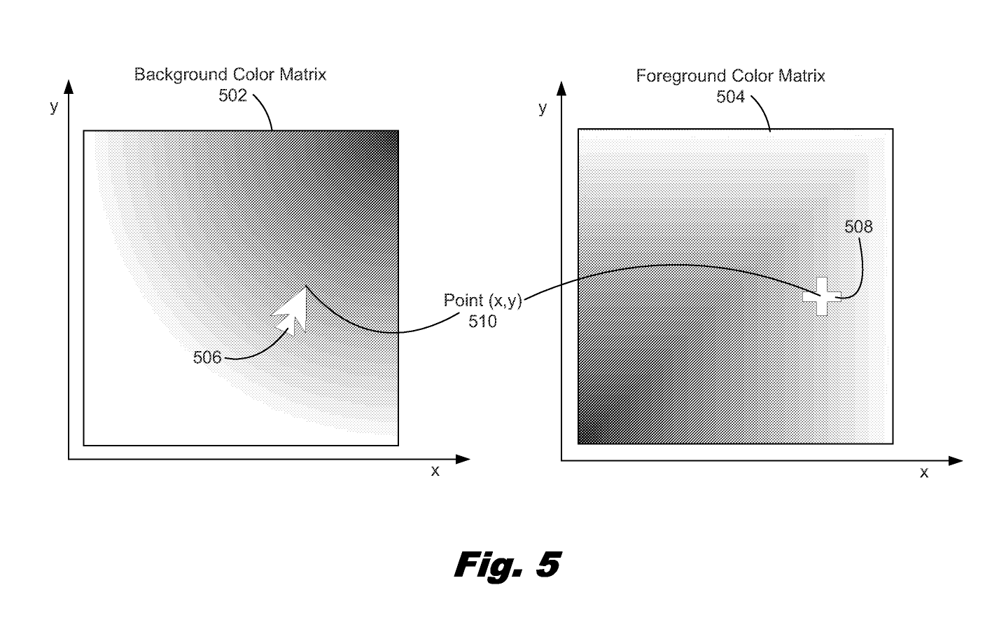

FIG. 5 shows a matched pair of illustrative background (502) and foreground (504) color matrices. In one embodiment, the background color matrix (502) could contain a gradient of colors with the darker colors at the bottom left and the lighter colors in the upper right. When viewing the color gradient from the bottom left to the top right, it can be seen that the colors gradually transition from the darker colors to the lighter colors. The foreground color matrix (504) could contain a similar appearance, only the darker colors are in the top right and the lighter colors are in the bottom left. When viewing color gradient from the bottom left to the top right, it can be seen that the colors gradually transition from the lighter colors to the darker colors.

As with previously depicted matrices, the foreground color matrix (504) can be pre-designed to match the corresponding background color matrix (502). When the user chooses a point on the background color matrix (510) using a cursor (506) or whatever means the application uses, the point corresponding to the same indices on the foreground color matrix (504) will be marked (508) as the corresponding foreground color. Though there is a higher resolution of color options, the amount of colors available is still finite. For example, the matrix may be of larger dimensions such as a 512×512 matrix.

It is not necessary that the color gradient in the foreground color matrix (504) be a direct inverse of the color gradient in the background color matrix (502). The color gradient of the foreground color matrix (504) may be predetermined by the developer to provide a matrix in which the color at every index is the match for the color in the corresponding index of the background color matrix (502).

Developers of many software applications are aware that computing resources are valuable and, in some cases, have limited capability. It is helpful to design software to consume as few processor resources as possible. This is especially the case when designing applications for smaller devices such as a cell-phone, digital music player, or Personal Digital Assistant (PDA).

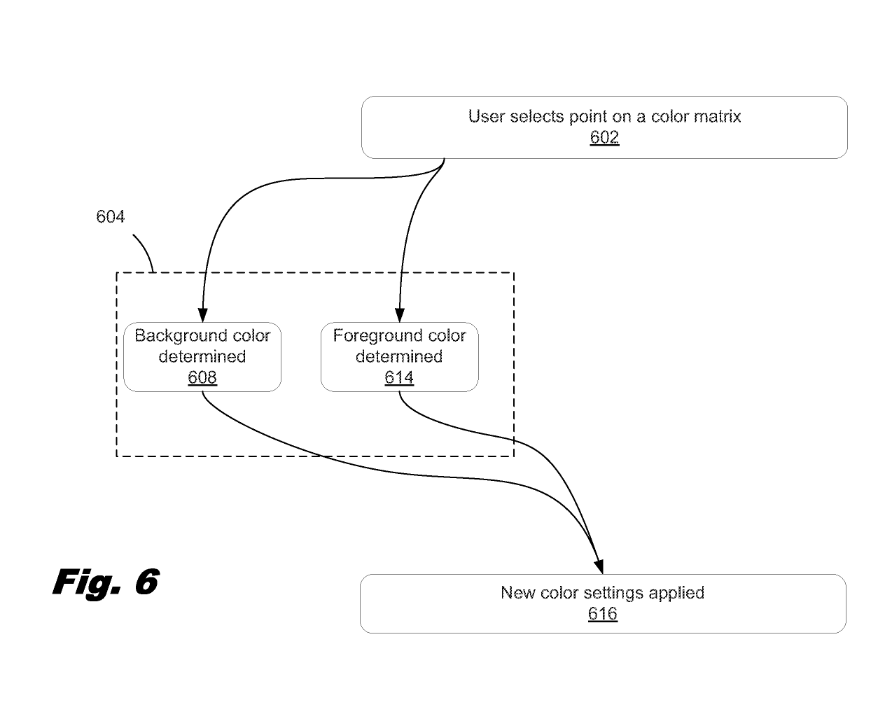

FIG. 6 is a flow diagram illustrating how a method for selecting a background and foreground color pair including with a display device and user input device, selecting a first color (602) from a first color matrix as a first color of the pair; and automatically determining (604) a second color of the color pair based on the first color.

More specifically, the user first selects the desired background color from the background color matrix or a desired foreground color from a foreground color matrix (602). A second color of the color pair is then automatically determined.

When the user selects a point on a color matrix through whatever means, the same matrix coordinates or other mapping function are used to determine a corresponding color from a related color matrix (604). For example, if the background color (608) from the background color matrix is selected, the method determines the corresponding foreground color (614) from the foreground color matrix. Alternatively, the user may select the desired foreground color from which a corresponding background color is determined as described herein. After both colors have been determined, the program may then apply the new color settings (616).

Although this specification generally describes how a foreground color may be selected from a user-selected background color, it may be equally desirable and effective to choose a background color based on a user-selected foreground color using the same methods. In some situations, the user may want the foreground color to be a specific color. In this case, the user would select a foreground color from a foreground color matrix. The background color would be selected from the coordinates in a background color matrix that match the coordinates of the user selected foreground color in a foreground color matrix.

In various embodiments, both a foreground matrix and a background matrix may be stored in a digital file. This would allow multiple programs or applications to access the same file when the user elects to change either the background color or the foreground color. For example, if a user changes the background color of an application's GUI, the application could perform a table look up to determine the associated foreground color from the file containing data which identifies background colors and matching foreground colors.

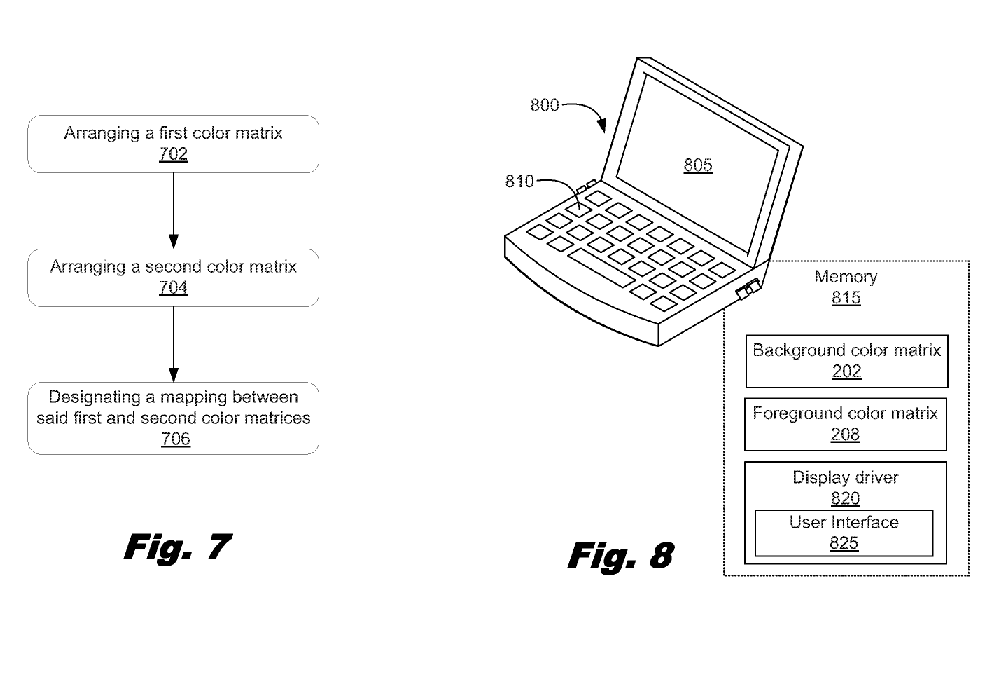

FIG. 7 illustrates a flow chart of a method, according an embodiment of the principles described herein, of making a user interface for selecting a background and foreground color pair. As shown in FIG. 7, the method includes arranging a first color matrix (702). This matrix may be either a background color matrix or a foreground color matrix.

Next, the method includes arranging a second color matrix (704). This matrix will be the complement to the matrix formed in the preceding step, e.g., either a foreground color matrix or a background color matrix.

Next, the method includes designating a mapping (706) between the first and second color matrices. This mapping identifies a second color of the color pair within the second color matrix based on selection of a first color of the color pair within the first color matrix, as described herein. The background and foreground colors can then be used for display of background and foreground elements, respectively, on a display device.

FIG. 8 is an illustrative drawing of a computing device according to one embodiment of principles described herein. As shown in FIG. 8, a computing device (800) includes a display device (805) and a user input device (810). As indicated above, the computing device may be any of a wide variety of devices including, but not limited to, a desktop computer, a notebook or laptop computer, a personal digital assistant (PDA), or a cell-phone. Accordingly, the display device (805) may be, but is not limited to, a monitor, display screen, flat panel display, television, liquid crystal display or other display device. The user input device (810) may include, but is not limited to, any of a keyboard, mouse, trackpad, touch-sensitive screen or other user input device. In the illustrated example, the computing device (800) is a laptop computer with an attached liquid crystal display device (805) and keyboard with trackpad (810).

The computer (800) also has a memory (815). This memory (815) is non-volatile and may be any physical device for storing computer- or processor-readable instructions including, but not limited to, a hard drive, Flash memory, optical disc and other forms of memory.

As shown in FIG. 8, the memory (815) has stored therein the corresponding background color matrix (202) and foreground color matrix (208) described herein. The memory (815) also stores a display driver (820) for controlling the display device (805). This display driver (820) may be loaded into the Random Access Memory (RAM) of the computer (800) and executed by the computer's processor.

The display driver (820) includes a user interface (825) that may be accessed by the user to control the background/foreground color pair as described herein. For example, once accessed, the user interface (825) may display one or both of the color matrices (202, 208) stored in the memory (815). The user may then select a color from a display matrix. As described herein, the display driver (820) will then match that color to a corresponding color in the other of the two matrices (202, 208) to produce a background/foreground color pair.

The display driver (820) will then drive the display device (805) is using that color pair for displayed elements. The display driver (802) may implement any of the methods, options or features described herein.

In sum, a method for determining a foreground color based on a user selected background color or vice versa is provided. In some illustrative embodiments, the available background colors may be represented by a matrix. A matrix of equal or lesser dimensions contains a set of foreground colors.

Each color in the background color matrix is mapped to a color in the foreground color matrix. When the user selects a background color, the foreground color is determined by whatever color the coordinate set of the user selected background color is mapped to. Both the background color matrix and the foreground color matrix may be stored in a digital file. This digital file may be accessed by multiple applications running on the same system, saving on memory space. This provides a simple way for a foreground color to be selected. It does not involve any computing resource consuming calculations. It will quickly produce a foreground color/background color combination that is readily legible, provides a minimal amount of strain on the eye, and is aesthetically pleasing.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A computing device comprising:
a user input device (810); and
a memory (815) comprising a display driver (820), a first color matrix (202) and a second corresponding color matrix (208);
in which a user interface (825) of said display driver (820) is configured to match a color selected with said user input device (810) in said first color matrix (202) with a color in said second color matrix (208) to identify a background and foreground color pair and to display background and foreground elements on a display device (805) using said color pair.

2. The computing device of claim 1, in which said first and second color matrices (202, 208) are a same size and a mapping of said display driver (820) corresponds each location in one of said matrices with a same location in the other of said matrices.

3. The computing device of claim 1, in which said first and second color matrices (202, 208) are different sizes.

4. The computing device of any preceding claim, in which at least one of said first and second color matrices (202, 208) comprise a color gradient.

5. A computer-readable medium comprising:
a background color matrix (202);
a corresponding foreground color matrix (208); and
a display driver (820) with a user interface (825) configured for selecting a color from one of said color matrices (202, 208) which becomes a first color of a background and foreground color pair;
in which, upon selection of a color from one of said color matrices (202, 208), said display driver (820) identifies a corresponding color from the other of said matrices to identify a second color of said color pair.

6. The medium of claim 5, in which only one of said matrices is displayed on a display device (805) as part of said user interface (825).

7. The medium of any preceding claim, in which said user interface (825) further comprises an example box (416) displaying a background and foreground using said background and foreground color pair.

8. The medium of any preceding claim, in which said user interface further comprises:
a background box (422) showing a selected background color; and
a foreground box (426) showing a selected foreground color.

9. The medium of any preceding claim, in which said background color matrix (502) and said foreground color matrix (504) each comprise a color gradient.

10. The medium of any preceding claim, in which said matrices (202, 208) are both of a single common size and said corresponding color is identified by being at a same location within said second matrix (208) as is said first color within said first matrix (202).

11. The medium of claim 5, in which said matrices (202, 208) are of different sizes.

12. A method for selecting a background and foreground color pair comprising:
with a display device and user input device, selecting (602) a first color from a first color matrix (202) as a first color of said pair; and
determining (604) a second color of said color pair based on said first color by selecting said second color from a second color (208) matrix based on a mapping function relating colors in said first color matrix (202) to colors in said second color matrix (208).

13. The method of claim 12, in which said first and second color matrices (202, 208) are different sizes, a color in one of said matrices being mapped to a plurality of colors in the other of said matrices.

14. The method of claim 12, in which said first and second color matrices (202, 208) are a same size and said mapping function identifies each color in said second matrix (208) as corresponding to a color at an identical location within said first matrix (202).

15. The method of any preceding claim, further comprising displaying a user interface (825) with said display device (805) in which a foreground of said interface is displayed using one color of said color pair and a background of said interface is displaying using the other color of said color pair.
